(19) United States
(12) Patent Application Publication
(10) Pub. No.: US 2010/0031262 A1
(43) Pub. Date: Feb. 4, 2010

(54) Program Schedule Sub-Project Network and Calendar Merge

(76) Inventor: Jill M. Baird-Gent, Owego, NY (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/183,236

(22) Filed: Jul. 31, 2008

(51) Int. Cl. G06F 9/46

(52) U.S. Cl. 718/102

(57) ABSTRACT

A master project file and one or more sub-project files are merged to form a merged master project file while avoiding date shifting, pointers to external files, accommodating equally named resources and calendars and accommodating split tasks which may otherwise be caused by differing settings or defaults for files created or modified on different processors or other incompatibility between the master project file and sub-project files by copying data reconstructed from the original settings, defaults and the like of the original sub-project file to descriptive fields in the merged master project file to resolve settings which must match between the master project file and the sub-project file while altering names of tasks or files as necessary and validating merged task data against the copied data.

### BACKGROUND OF THE INVENTION

1. Field of the Invention

The present invention generally relates to planning and execution of a project program over a networked enterprise and, more particularly, to merging documentation developed from various parts of a networked Master Schedule into a Merged Master File document for the overall program.

1. Description of the Prior Art

Complexity of products and services which may be currently required is increasing at a rapid pace such that many products and services may only be developed by relatively large enterprises employing hundreds if not thousands of skilled technicians, engineers, designers and the like, approaching the development of various aspects of the product or service individually or in groups, generally over an extended period of time. It is often the case that particular facilities or sites of a large company that may be widely separated geographically may have certain aspects of the project assigned to them in order to bring the most relevant accumulated expertise to bear on respective problems related to the product or service. For those reasons, it is of extreme importance that the development of a product or service be scrupulously documented to fully describe all aspects of the product or service and all portions thereof so that all aspects of the product or service and their status during development can be accurately known throughout both the development and entire commercial and service lifetime of the product or service. Doing so is especially important for coordination of aspects of the project across the enterprise during development and to describe and facilitate use and management, including repairs, upgrades and the like for reference by users of the product or service.

Generally, such documentation will be accumulated during planning, design and development of the various and potentially very numerous portions of the enterprise charged with development of the respective various aspects of the product or service while a master document for coordination of the respective portions of the enterprise is separately kept. Thus at various points in time, it is desirable to update the master document with the sub-project documentation (itself often developed from sub-sub-project documentation over potentially many hierarchical levels into which a project may be divided and distributed over an enterprise) that is developed by the respective portions of the enterprise as well as to provide plenary documentation for the product or service when its development is complete and the product or service is deemed ready for delivery or deployment. That is, it is very desirable in many circumstances to have a single, often large, document covering the entire project and derived from documentation of separately developed documentation of respective portions of the project that can be kept up to date and distributed as may be desired for reference purposes within the enterprise, for reporting of progress to potential customers and other purposes.

While several software products are commercially available for merging documents, including scheduling documents, the potential complexities that may be encountered in merging documentation of the types discussed above are very numerous and some of these complexities are treated, if at all, in different and not necessarily desirable or even acceptable ways in the respective commercial software products. Such deficiencies of commercial software products may possibly be due to a perceived need for such commercial software product to be more universal for generalized text merging and/or lack of internal data validation or conversion required when cross-project links must be converted to internal links within the master file, imposing some inflexible hierarchy or parity between files being merged for purposes of matching of settings, resolving inconsistencies of calendars, defaults and error checking between documents or the like. The details and particulars of processing of documents during merging of documents and the capability to alter or customize the performance of commercial software products for merging of documents is often not well documented or the results even particularly predictable in practice and, in many cases, may even lead to errors of major severity and significance in the resulting merged document.

### SUMMARY OF THE INVENTION

The present invention provides an algorithm to merge sub-project (including hierarchically lower) files and a master project file into a Merged Master file with predecessor and successor tasks pointing only to non-external tasks in the Merged Master file while maintaining schedule dates by using base calendars, task calendars and resource calendars transferred from sub-projects, separately managing equally named resources and calendars, properly managing and maintaining split tasks (e.g. single tasks that have additional specified start dates for particular portions thereof that may be required to wait for completion of other tasks such that they may not be performed continuously until completion), assuring data integrity and removal of potential duplicate predecessor and successor cross-project links even when generated or existing in files to be merged.

Accordingly, a method and computer program product for merging document files relating to a project comprising a master project file and sub-project files are provided for performing steps of validating and backing up all document files to be merged, backing-up master project file task data to baseline and number fields, resolving inconsistencies between the master project file and sub-project files using constraints and matching settings, for each sub-project file to be merged, disconnecting the sub-project file from its physical storage location, converting pointers in the sub-project file to point to tasks in the master project file to form a converted sub-project file, deleting duplicate task links to form a converted sub-project file, and grouping by original project and resource names, merging each converted sub-project file with the master project file to form a merged master project file, and updating tasks where task data changed due to the disconnecting step.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is an overall algorithm (flow chart) of the document merge process in accordance with the invention,

FIGS. 2A, 2B and 2C are detailed algorithms (flow charts) of respective portions/subroutines of the flow chart of FIG. 1,

FIG. 3 is a comparison of results of merging of files and the incorrect date-shifting and pointer results delivered by a commercial file merging process,

FIG. 4 illustrates, in a similar fashion the incorrect result of document merging in regard to equally named but distinct resources in different documents,

FIG. 5 illustrates the correct merging of files in accordance with the present invention,

FIG. 6A and 6B illustrate, in a similar fashion, incorrect results of merging documents by commercial document merging software in regard to split tasks and FIG. 6C illustrates correct results achieved by the invention,

FIGS. 7A and 7B illustrate the inadvertent duplication of links in original documents and FIG. 7C illustrates correction thereof when updating link data during merging of documents in accordance with the invention, and

FIG. 8 is a diagram of a preferred interface for launching the document merge process in accordance with the invention.

### DETAILED DESCRIPTION OF A PREFERRED EMBODIMENT OF THE INVENTION

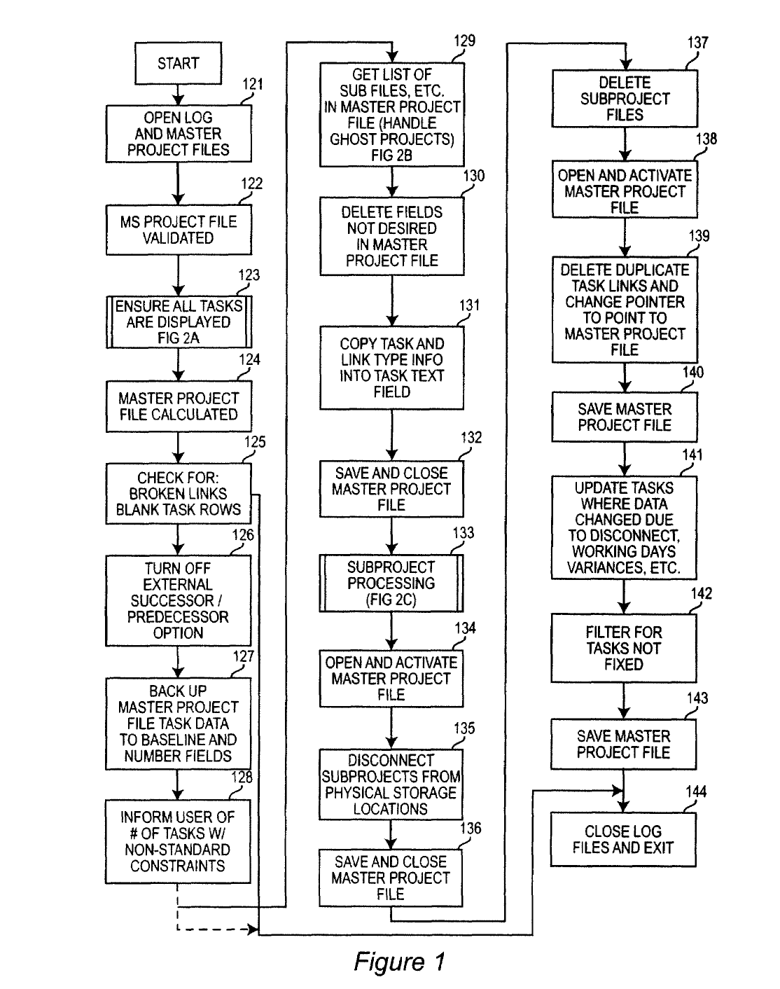

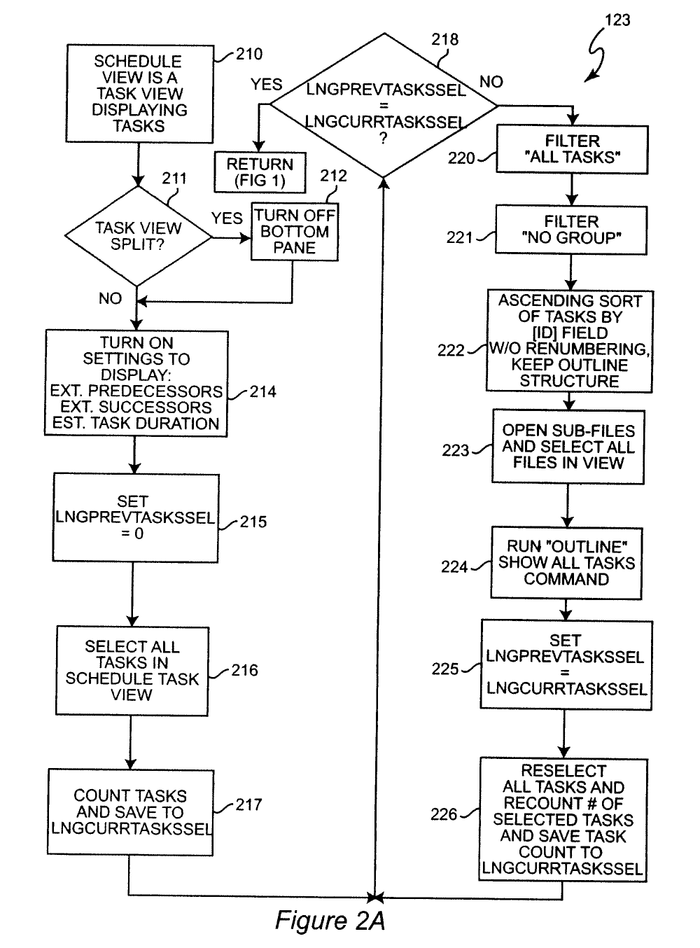

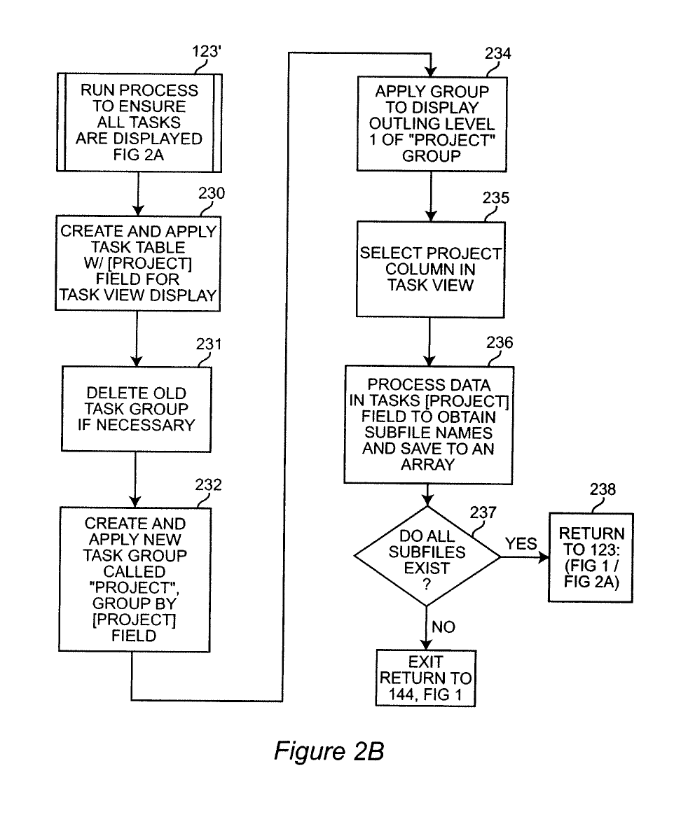

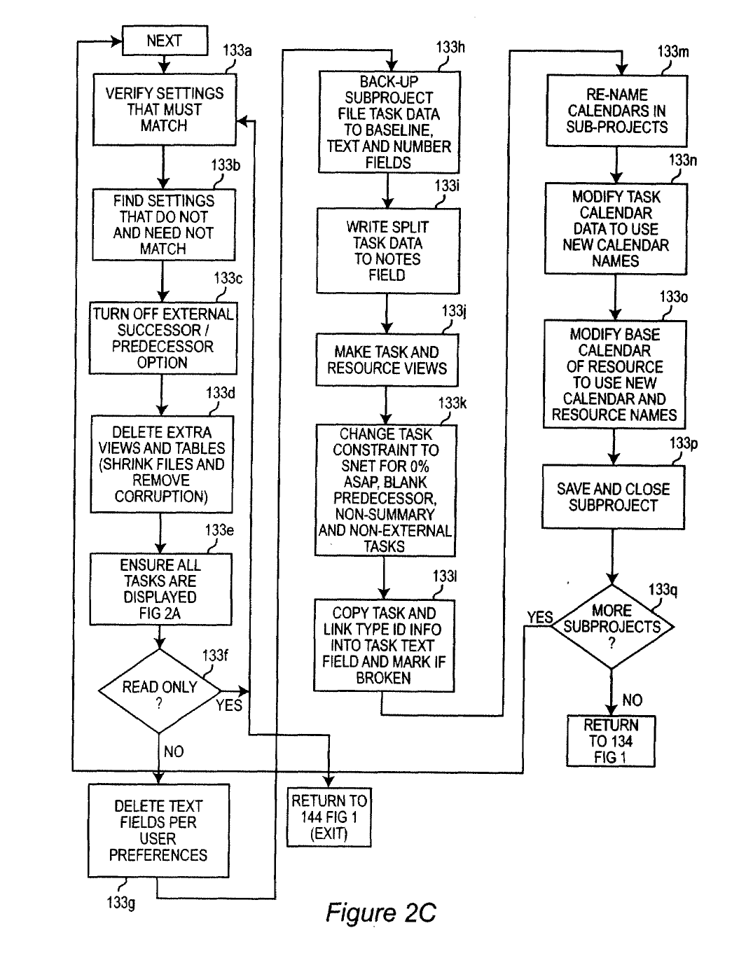

Referring now to the drawings, and more particularly to FIG. 1, there is shown an overall flow chart of an algorithm in accordance with the preferred document merge process of the invention. It should be understood that this process is preferably implemented in software (preferably written in Microsoft Visual Basic™ language) as a computer program product and those skilled in the art will therefore recognize that FIGS. 1 and 2A-2C can also be understood as a data processing pipeline embodied by one or more suitably programmed hardware processors configured by the program to provide the corresponding functions or functional elements; which program, itself, may be embodied in many ways such as being stored on a computer-readable medium or provided through a communication link. Thus FIGS. 1 and 2A-2C should also be understood as illustrating data processing apparatus corresponding to the illustrated operations.

To further elucidate the problems with commercially available products for merging of schedule files as discovered by the inventor, it should be understood that some scheduling software is available and typically used for producing documentation of the sort appropriate to the development of products and services and which are intended to facilitate the anticipated merging of schedule files. In many cases, such adaptations of more generalized scheduling software assume or are optimized for a degree of parity between files of a given project which are to be merged and do not run or run very slowly on sub-project files and master project files for merging them into a Merged Master file, especially in regard to predecessor and successor tasks pointing only to non-external tasks in the merged master file, maintaining schedule dates, calendars, split tasks and critical paths within the overall project or maintaining required data integrity and validation of potential duplicate predecessor and successor cross-project links.

That is, it is common for commercially available word processing and/or scheduling software to facilitate data entry and document creation and modification by employing certain default or pre-set setting, local (e.g. to a project or sub-project) conventions and pre-established sequences in naming of resources and related data files (e.g. calendars) and incorporating information from other linked files or documents; any of which can be sources of incompatibility or inconsistency between files pertaining to other projects or sub-projects and which can lead to errors and changes of data when documents containing such incompatibilities or inconsistencies are merged. In general, small numbers of errors which may result are relatively trivial to correct individually and manually by a person well-versed in the conditions and circumstances of various sites or operations involved in the enterprise although such expertise can be relatively rare. However, the numbers of circumstances in which such errors may occur during merging of documents for an enterprise of even modest size may run to the tens or hundreds of thousands. Automation of corrections in the manner of manual operations could, in theory, be simply automated by a relatively simple program if the causes of the errors are relatively few and reasonably consistent. However, in practice, the difficulties of accommodation of large sets of different and often mutually exclusive settings (e.g. “always” or “never” split tasks), ambiguities due to equally named resources and calendars among files to be merged and the like are often insurmountable and approached, if at all in commercial document merging software, by consistently applying one or, at most, a small number of easily executed conventions which often are not appropriate to the actual documents being merged or the settings and naming conventions by which they were created much less the number of linked documents which may be referenced.

More specifically, it has been found that some schedule merging software does not merge the sub-project data into the existing master file at all but assembles a new schedule file or assembles a virtual network of links to original sub-project documents which are subject to continual change with new information input thereto. Therefore, not only is no consistent and stable document or schedule provided between plenary updates but any internal revision for consistency or modification of links appropriate to a master document may be propagated back to the underlying documents which may be and often are the original sub-project file(s); causing errors therein or even multiple inconsistent information entries in an unpredictable and largely undetectable manner preventing the correct data from being ascertained (or, sometimes, even detected other than by inspection) among corresponding erroneous data.

Even if such potential for multiple inconsistent versions of particular data is avoided and the commercially available software accommodates master and sub-project files, inconsistencies are generally resolved based on the hierarchical relationship between the files. For example, if a data item in a sub-project file is inconsistent with a corresponding data item in a master project file, particularly if done through settings or defaults resident on the processor on which the document was created or edited, the version of the data in the master project file is generally used. This convention can be readily understood to preclude at least some updates from data entry into the sub-project file and possibly obsolete, inconsistent, potentially duplicative but inconsistent information generation or otherwise erroneous data which could be propagated back to the sub-project files. Such generation and propagation of errors is particularly common and particularly critical in regard to durations, time-critical paths and critical dates in a plan of execution of a project. Merging sub-project and master project files into a single Merged Master file can generate schedule inconsistencies that cannot be readily resolved such as unnecessarily scheduling work on a work day in the country corresponding to the master file which is a holiday in the country where the sub-project is performed, scheduling activities for which necessary resources are not available or failing to schedule activities during periods when a task must be performed based on a task calendar.

Other points of file incompatibility which cause errors or compromise consistency within a merged master project document can arise from many sources such as (but certainly not limited to) differences in performance of task updates between files, duplicate links being automatically generated in a document, option settings (e.g. split tasks due to option settings; tasks which are manually split are often handled correctly), project file start dates and the like which will be collectively referred to hereinafter as “settings”.

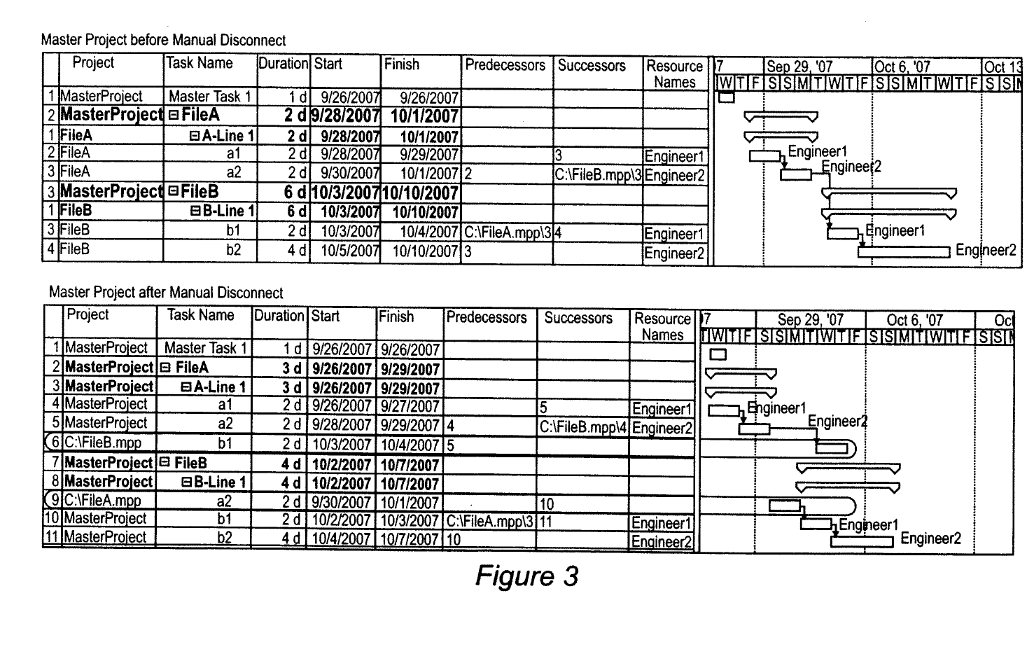

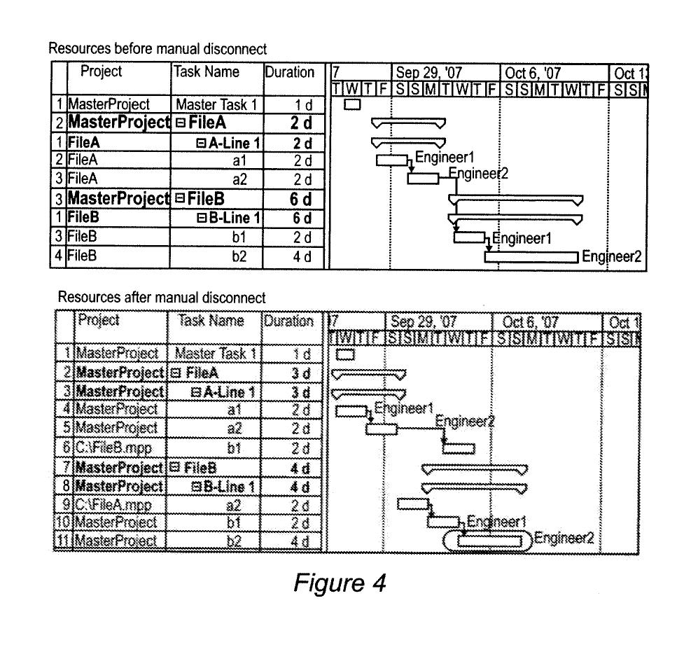

FIGS. 3 and 4 illustrate some examples of errors which can be generated. The upper portions of FIGS. 3 and FIG. 4 illustrate the data before a possible merge process is applied. The left side of each of the upper and lower portions of FIG. 3 is a task view showing project name, task name, durations, dates and relationships between particular related and interdependent tasks in respective fields and cells. (The relationships between related and interdependent tasks are referred to as predecessor or successor fields. Other fields may or may not be dedicated to particular information such as project, group, resource, ID baseline, task name, text, notes, back-up, flag, dates and the like or other numbered and/or custom fields, collectively referred to as descriptive fields.) The left side of each of the upper and lower portions of FIG. 4 is a task view showing project name, task name and duration. The right side of FIG. 3 and FIG. 4 is a graphical representation of a time line with illustration of allocated resources and links between tasks. The lower portion of FIGS. 3 and FIG. 4 illustrate typical erroneous artifacts which can be generated by a manual process or commercial software for merging of schedule documents. The actual causes of errors depicted therein may be difficult to attribute in view of the general complexity of such commercially available software. However, examples of artifacts illustrated will be sufficient to convey an understanding of the importance of avoiding them.

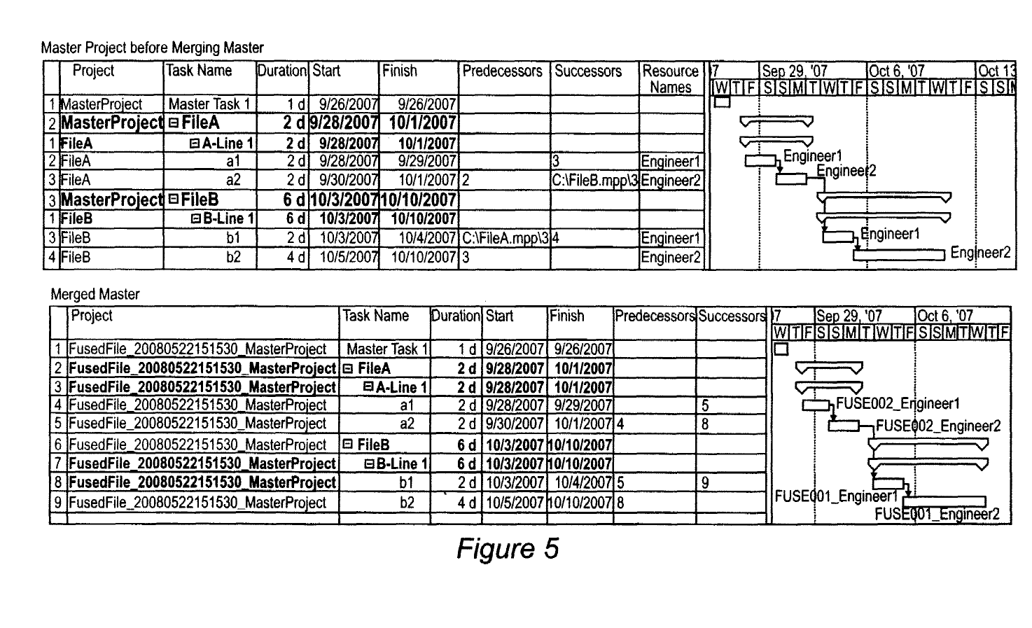

The upper portion of FIG. 5 illustrates the data before the merge and the lower portion of FIG. 5 illustrates a correct result of merging of two files and a corresponding time line. That is, the lower portion of FIG. 5 illustrates correct representations and modifications which are generated by the present invention for merging of documents. The left side of each of the upper and lower portions of FIG. 5 is a task view showing project name, task name, durations, dates, task relationships and resource names of particular related and interdependent tasks. The right side is a graphical representation of a time line with illustration of allocated resources and task relationships.

In the simple case illustrated, the MasterProject file contains one task called Master Task 1, and two interrelated sub-projects, FileA and FileB, each having three tasks: A-Line 1, a1, a2 and B-Line 1, b1, b2. Additional lines (FileA and FileB) are called project summary tasks and tasks therein are provided in outline format for the project summary tasks. The two sub-project files are interrelated at tasks a2, b1, as indicated by the data in the predecessor and successor columns of the task sheet indicating that task a2 must be completed before task b1 can be started. This link is shown in the time line using an angled arrow following the activity labeled “Engineer2” in the upper portion of FIG. 3, FIG. 4 and FIG. 5. (As illustrated, the task relationship shows a one day “cushion” between these tasks in the horizontal portion of the angled arrow to accommodate a different project start date, holiday, employee schedule or the like.) The “C:\FileB . . . ” and “C:\File A . . . ” data in the predecessor and successor columns show that the tasks are linking between two different files.

In the lower portion of FIG. 3, the interrelationship between the sub-projects A and B is manifested by simply appending task b1 to file MasterProject, showing the successor link as the source and adding task a2 to file MasterProject, showing the predecessor link as the source; thus providing two separate additional lines for each of the sub-project tasks a2 and b1. This duplication of lines corresponds to the same task, but points to the original sub-project files (C:\FileB . . . ” and C:\FileA . . . ”) rather than to the tasks a2 and b1 that now exist in the file MasterProject. Thus, even if no data is lost (e.g. the proper dependency is reflected in each of sub-projects A and B, respectively), the overall dependency of the MasterProject file tasks are changed to a dependency internal to each respective (sub-)project. Thus, (without being held to any particular speculation about underlying causes) manual processes, scheduling engines or the like which may be included in the commercially available document merging software appear to only accommodate internal consistency within sub-projects or provide some similar effect during merging of documents and, therefore, schedule dates may shift.

More specifically, note that in the lower portion of FIG. 3, there are actually two a2 lines and two b1 lines as alluded to above. Both a2 lines have different dates, as do both b1 lines, but there is, in reality, only one a2 and one b1 task that has to be completed. As a result, there is no critical path through both tasks a2 and b1 that is completely contained within the merged file MasterProject. Thus, importantly, the schedule dates for the non-external tasks in the file MasterProject are changed in a manner that may make the schedule impossible to meet or even start as scheduled. Nevertheless, it is desirable that the optimum schedule be provided when sub-project documents are merged with a master project document and provision of a scheduling engine of the like in project document merging software is thus desirable although errors of the type engendered as discussed above have thus been unavoidable in the prior art.

As another example, the lower portion of FIG. 4, shows a problem with manual processes or commercial software when varying resource calendars are used but where the resources or corresponding resource calendars may be commonly/equally named. The resource “Engineer2” is assigned to task a2 and to task b2, but the resources thus commonly/equally named are, for purposes of this example, different people at different locations and each has a different resource calendar. Task a2's Engineer2 (in FileA) works seven days each week, but task b2's Engineer2 (in FileB) works five days a week and does not work on Saturday or Sunday. FIG. 4 shows the result of manual disconnect (a process provided in some commercially available software which disconnects sub-project data from its source file but allows pointers to other files to remain) and the resulting move of the resource for FileB's task b2. In the top section of FIG. 4, task b2 shows Engineer2 works 4 days from Friday through Wednesday. This is 6 calendar days, but it is only 4 days of working time, because FileB's Engineer2 doesn't work on Saturday or Sunday. In the bottom portion of FIG. 4, Task b2's Engineer2 works Thursday through Sunday. The resource's working days have thus been moved, and this could make the schedule impossible to meet or even start as scheduled. This type of error could occur as a result of standard, custom, task or resource calendars.

To avoid these effects of commercially available software for merging of project documentation, the invention provides a largely automated methodology for merging of documents which sequentially validates various categories of data and selectively repairs inconsistencies by matching of settings among documents being merged. The invention also provides for monitoring or tracking of errors such as those discussed above including date shifting, pointers between external tasks and errors induced by equally named resources, calendars or other (e.g. so-called standard) calendars (and also proper handling of split tasks and duplicate tasks in original documents as will be discussed below) which can occur from a merge operation so that such errors may be corrected or removed or, in some cases, the merge process halted or prevented when the occurrence of uncorrectable errors can be projected. Thus, the invention preserves the substance of the original dates and settings notwithstanding incompatibility between documents to be merged and the settings with which the documents were created or modified.

The bottom portion of FIG. 5 shows the result of the Merged Master file produced by the invention. The Merged Master file was renamed, but, importantly, not recreated, allowing the Master Project file settings to remain unchanged. This is especially important if the user's (e.g. of a particular processor having user defined settings resident thereon) default option settings for creation of a file do not match the Master Project's option settings. (Each user has settings and default settings such as to always or never split tasks. Thus, if a new file is created, settings in the original file may change to those resident on the processor.) All tasks are contained within one Merged Master file, as can be seen in the project field data column. All task dates in the lower portion of the FIG. 5 match the original task dates in the upper portion of FIG. 5. To preserve the critical path, Task a2 is now linked to non-external task b1, not to an external task in the original “C:\FileB.mpp” file, which is evident in the Predecessors and Successors column data.

To accommodate equally named calendars and tasks and resource assigned to them, a prefix is preferably added to each Base Calendar name and it is included in the Merged Master. A prefix is also preferably added to each Task Calendar name and they are included and assigned in the Merged Master, to accommodate tasks with assigned task calendars. A prefix is also preferably added to each resource name's calendar and name, to handle varying calendars for identically named resources in more than one project. The prefix or other alteration of resource or calendar names such as inclusion of a symbol serves to differentiate the otherwise equally named resources or calendars in accordance with their respective sources. Therefore Task Dates are correct, even when a task has no predecessor, and also when cross-project links haven't been updated between sub-projects. Thus, the process in accordance with the invention ensures that each schedule resource has a distinctly separate calendar, such as to accommodate two identically named resources in two separate sub-project files that have different working days. To allow for resource grouping by file, the sub-project file name is copied into each Resource's group field. To allow grouping by identically named resources, the users can copy (manually or, preferably, automatically by the software in accordance with the invention) the sub-project and Master Project Resource Names into a Resource Field, before merging the Master Project while preferably tracking execution of the merging process which may assist in failure identification although such tracking is not necessary to the successful practice of the invention.

Returning now to FIG. 1, the process begins with opening the master project and, preferably, log files (121) and the like files. The project schedule file is then validated in step 122 to ensure that the project file is not read-only, is a master project, doesn't schedule from the finish date, and to obtain project file option settings such as EV (“earned value”—in accordance with the schedule proportion of work done in the task) method and “honor constraints”. Step 123 ensures all tasks are available (at least sufficiently to be displayable) and preferably displayed and expanded, including sub-projects, sub-sub-projects and projects of any sub level. This function is preferably achieved through use of a sub-routine which is illustrated in detail in FIG. 2A.

When processing all tasks in a Master Project, it is necessary to first ensure that all tasks and files to be merged are available and displayable for user review and confirmation for being merged even if they are tasks at very low sub-levels or tasks contained within sub-projects, sub-sub-projects and the like. The process illustrated in FIG. 2A thus probes files in a nested looping manner throughout the Master project to discover and display all tasks which are referenced at any level in any inserted file and thus presumably related to the Master Project. To ensure completeness of the probing, two variables are defined:

lngPrevTasksSel—the count of previously displayed and selected tasks, and

lngCurrTasksSel—the count of currently displayed and selected tasks,

although any name can be used for the variable that is a valid variable name for the processing software.

First, the display format of the schedule is checked at step 210 to determine that the particular schedule view presented is also a task view displaying representations of tasks in a manner such that the particular tasks will be identified to the user. Step 211 determines if the display view is a split view having more than one pane or page. If so, all but the top pane or page are turned off at step 212 to allow the task being currently processed and sub-tasks found within it to be presented to the user (e.g. in a scrolling fashion). As depicted in step 214, settings for the display are turned on such that external predecessors, external successors and estimated durations of respective tasks are displayed. This step or these operations can be performed at any time as long as they are completed before continuing with the remainder of the process.

To begin the actual task processing, the variable lngPrevTasksSel is set to zero as depicted at step 215 to provide a starting value for the variable and all tasks displayed in the schedule/task view are selected, as depicted in step 216. Thus, this selection can be performed automatically and without user supervision. The currently displayed tasks are then counted and the count saved to the variable lngCurrTasksSel, as depicted at 217. Then, the two variables are checked for equality as depicted at 218. This condition cannot be satisfied the first time step 218 is performed and the process initially branches to step 220.

In steps 220 and 221, the tasks are filtered with an “all tasks” criterion to include all tasks not previously selected and a “no group” criterion, respectively, to remove grouping of view data. Then, in step 222, the tasks are sorted in ascending order of ID field content but are not renumbered and the outline structure is preferably not changed. All tasks in the view and now included by the “all tasks” filtering are selected as depicted in step 223 and the sorted tasks are then re-displayed by expanding the outline hierarchies in the view so that non-displayed sub-levels are displayed as depicted at step 224. The variable lngPrevTasksSel is then set to the value of the variable lngCurrTasksSel set at step 217. The tasks are then re-selected and re-counted at step 226, the displayed tasks are selected and the number of displayed tasks is saved to the variable lngCurrTasksSel (altering the equality previously set if all tasks at all sub-levels have not yet been selected and displayed) and the comparison of step 218 is repeated. Thus the process of steps 220-226 will be repeated in a looping fashion until the two variables are equal, indicating that all tasks at all hierarchical levels have been found and have been displayed.

Returning to FIG. 1, step 124 ensures that the fully expanded master project file is calculated, in case manual calculation has been set, or if calculation is required for some other reason. Step 125 searches for broken task links (predecessors or successors linking to sub-project files that are not contained within the master project file), and blank task rows. If broken task links and/or blank task rows are found, the process will shut down.

Then, once the integrity of the master project task file is established or confirmed, the predecessor/successor display options are turned off (step 126) and the master project task data (e.g. dates, % complete, duration and the like) is backed up to Baseline and Number 1-3 fields in step 127. The number of tasks with non-standard constraints is then determined and displayed to the user in step 128. If any constraints that are not “As Soon As Possible” or “Start No Earlier Than” are found, the user is warned, and the user can decide if the process should end or not.

It should be understood that, as a matter of efficiency in situations where more than one enterprise may exist at a given time and may involve some similar technologies which are being developed, it may be preferable or more efficient to provide for at least a portion of the development of such a technology within a particular enterprise even though it may be principally deployed in another enterprise. Tasks can thus be linked to tasks within sub-project files that have been deleted or are unavailable to the user. These non-existent or unavailable sub-project files are referred to as “ghost projects” and it will generally be desirable to omit their documentation from the master file of a particular enterprise or project. Therefore step 129 shown in greater detail in FIG. 2B essentially obtains a list of all sub-files, sub-sub-files, etc. and, if any projects are unavailable or non-existent, then the process will end.

The process/sub-routine illustrated in FIG. 2B finds the paths and names of all project files in a Master Project regardless of level. To assure that all files and tasks are included and displayed, the process described above in connection with FIG. 2A is again performed as depicted at 123′ (in this instance, again operating on Master Project files). Then, a task table containing the “Project” field is created and applied to the display to ensure that the “Project” field is displayed, as depicted in step 230. Alternatively, a “Project” field could simply be appended to the current task view or this step omitted altogether if the “Project” field is included in the current task view. If the “project” task group exists, it is deleted in step 231. Then, step 232 defines a new “Project” group to group the tasks by the content of the “Project” field content in descending order. The view of the display is then changed to apply the new group and to limit the display content to only the first outline level of the “Project” field content in the “Project” group, as depicted in step 234, preliminary to developing the desired format in the merged task list. The project column is then selected (step 235) and the data in the “Project” field is processed by comparing the data in the “project” field cells to the “project summary tasks” project field to obtain sub-file names, as depicted in step 236 and saved in an array to make a list. Using the sub-file names so obtained, a search can then be made for corresponding sub-files and, if such a sub-file is found, its name is loaded at step 238 and the process is repeated to find sub-files at increasingly lower levels of the tasks. If no file having the sub-file name is found to exist, the process returns to step 144 of FIG. 1 and thus exits. Otherwise, it is preferable to return to step 123 to re-run the process of FIG. 2A as discussed above which changes the display format to display all files.

The user interface allows the user to select to delete data in the customizable fields in order to shrink the final size of the merged master file. The user can also select to keep most of the data in the customizable fields in order to retain that information. Step 130 performs the action of deleting customizable field data as the user selected. Task and link type identifying information is then copied to a task text field of the file, only for tasks that have external successors with cross-project links and, preferably where the “project” field equals the “project summary tasks” “project” value, in step 131. This completes the editing, verification and documentation of the master project file which can then be saved and temporarily closed in step 132.

Step 133 is a composite step detailed in FIG. 2C which essentially processes each sub-file to be merged into the master project file to achieve compatibility prior to the document merging operation. First, in step 133a, the settings which must match settings in the master file are verified, such as “Schedule From Start”, “Honor Constraints” and “EV Baseline”, and the process will end if the required matching settings don't match. The settings that do not need to match may then be displayed for confirmation by the user at step 133b.

The successor/predecessor information is then hidden by turning off an external predecessor/successor option, because the process doesn't need to look at external sub-project tasks while working on a single sub-project file, as depicted at step 133c. Then, extra illustrations and tables not necessary in the master project file are deleted at step 133d. This step reduces the likelihood of the breaking of otherwise good files that may be more likely to occur due to some incompatibility of the software or file corruption in which such views, filters and tables may be incorporated into the sub-project file. This step also reduces overall file size and removes any file corruption which may be present in the file in connection with such views and/or tables. Then, after such deletion, it is desirable to ensure that all tasks associated with all layers of the sub-project are displayed, as depicted in step 133e by again repeating the process described above in connection with FIG. 2A. It should be noted that performance of step 123 described above operates on master file data while the instances of the process of FIG. 2A as performed at this point of the process operate on data of respective sub-files. If, on the other hand, the file is opened in a read-only mode so that such deletions cannot be made, the run is preferably ended for this sub-project as depicted at step 133f.

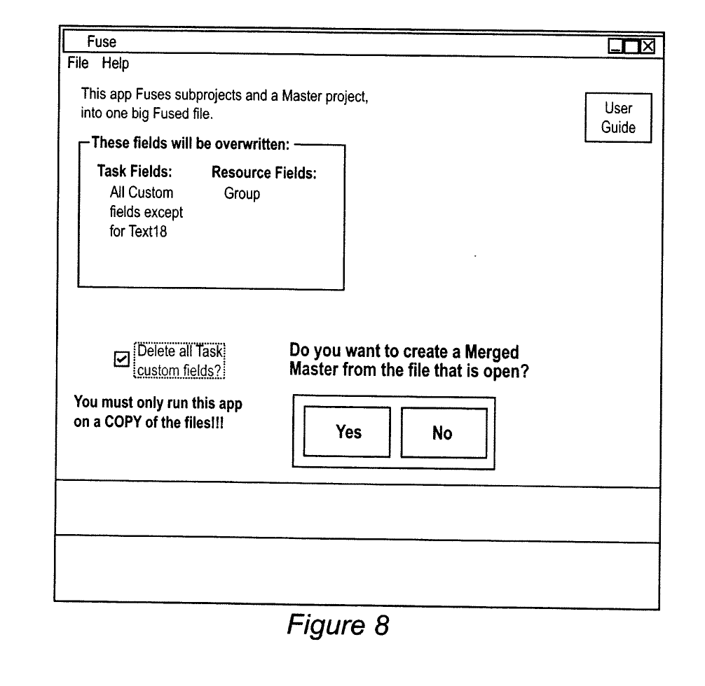

Alternatively, these operations (133d-133f) could be performed earlier as part of step 133a. However, steps 133a-133c may be executed rapidly and it is deemed to be preferable to separate steps involving possible user intervention or options from those that do not to avoid confusion of a user (that is presumably generally familiar with the document merging process) in regard to the nature of the changes that will occur when control is exercised. Additionally, text fields may optionally be deleted at the will of the user as depicted at 133g. The user's selection on the interface (FIG. 8) determines the delete action. The task data stored as described above at step 127 is then backed up at step 133h to provide for backup of any sub-project data that may be changed when the files are merged.

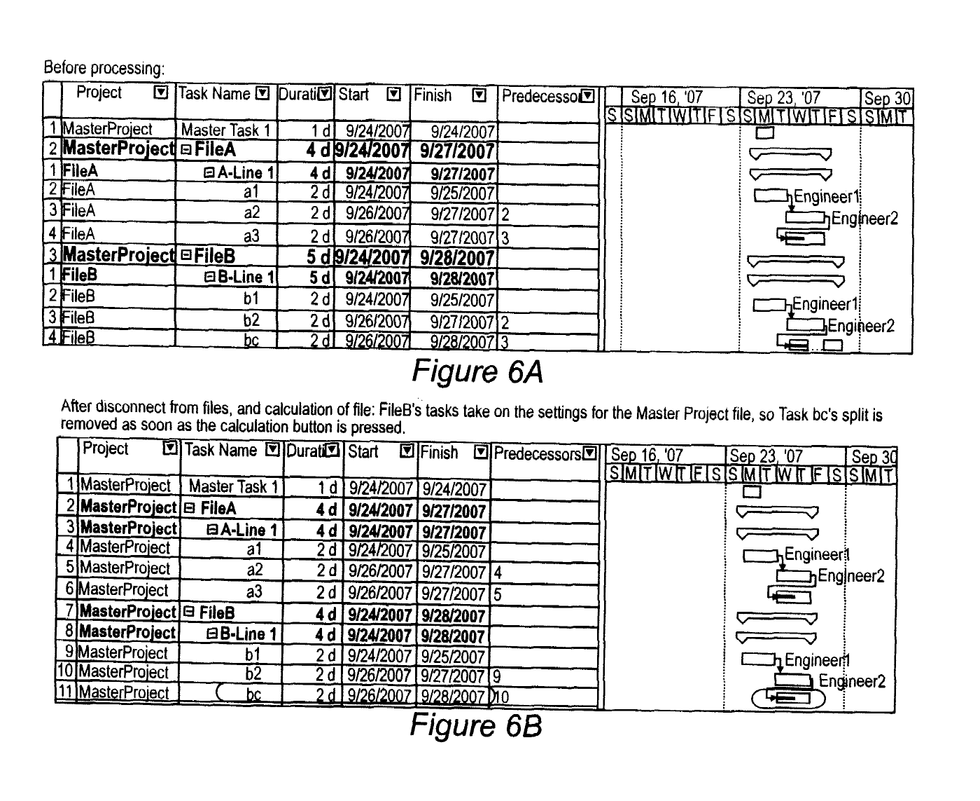

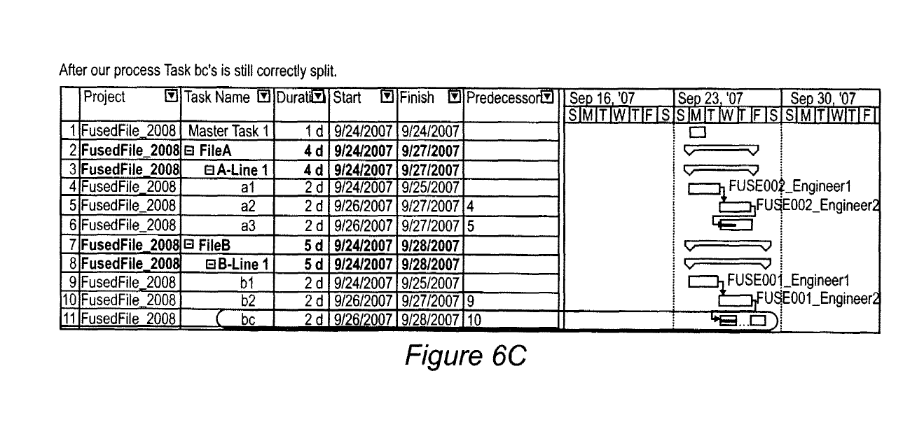

As a perfecting feature of the invention which is not necessary to the successful practice thereof to avoid date shifting, duplication of tasks, pointers to external tasks and errors due to equally named resources and calendars alluded to above and which errors are avoided/corrected by the invention, it should be appreciated that a special case of date shifting may be presented by the original data which the invention may preferably address as well. Specifically, tasks may be presented that are preferably not performed by a continuous process but which are scheduled with one or more interruptions to accommodate predecessor processes or resources that are only required for a portion of the task subsequent to its start and possibly a significant portion of the process. The process is then preferably halted at a particular scheduled point and restarted after the processes or resources necessary for its continuance have been performed or made available. Such tasks that are scheduled with one or more interruptions are thus referred to as “split tasks”. The processing thereof in accordance with this perfecting feature of the invention will now be explained with reference to FIG. 6A-6C. It will be appreciated by those skilled in the art that the particular processing in accordance with the invention also serves to correctly handle such split tasks even if master project settings are set to not split “in progress” tasks and sub-project settings are set to split “in process” tasks.

In FIG. 6A, line 4 of FileA of the master project is directed to a two day task a3 which is not split while line 4 of FileB is also directed to a two day task bc which is desirably split and performed over three days with a one day hiatus such that the second part of task bc may be delayed until some necessary resource is available or some other task is completed. After the tasks are disconnected from their corresponding sources or files using commercial merging software, it is often found that tasks corresponding to a sub-project (e.g. FileB), particularly if established by settings resident on the processor on which the file was created (but usually not if the task was split manually) often take on the settings for the Master Project file. Therefore the split of task bc is removed as soon as calculation of the merging process is initiated as shown in FIG. 6B. However, the processing in accordance with the invention as will be further described below correctly maintains the split as shown in FIG. 6C.

Specifically, Task Split Parts data is copied to the notes field in the file as depicted at step 133i. This operation allows for mixed split file settings between files, handles multiple split parts in a task, and ensures split tasks will be correctly shown in the merged master file and is thus preferred but could be omitted if it is guaranteed that no split tasks are included in the documents or that any split tasks that are presented are scheduled manually and not under control of processor settings which, in any case, are monitored by the invention in the course of monitoring for date shifting during document merging as will be discussed below. In this regard, since the master file will be changed and some data edited, and the sub-project files ultimately deleted, as will be explained below, it is substantially obligatory to protect existing data and that the invention only be provided with copies of original electronic files for processing in accordance with the invention, as is also preferably included in the interface of FIG. 8 and/or that files be automatically copied and identified as copies as part of the initiation of the process in accordance with the invention. Therefore, the final merged master of the master file used and input to the invention will be validated against the backed up data in the backup fields. Task and resource view graphics can then be created as depicted in step 133j. Using these views, the task constraints are then changed to “Start No Earlier Than” (SNET) in step 133k for tasks that are 0% complete with an “as soon as possible” (ASAP), a blank predecessor field, and are non-summary and non-external tasks. This action will keep those tasks from moving when the master project's “project start date” is different from the sub-project's “project start date”. It should be noted that step 133k can be performed later in the process in accordance with the invention but can be more quickly performed if performed at this point in the overall process.

Task and link type identifying information is then copied to a task text field and marked if broken as depicted at step 133l. Then, the calendars in the sub-project and lower level projects are renamed as depicted in step 133m and the task calendar of the task data and the base calendar of the resource data and the resources are renamed as depicted at steps 133n and 133o to use the new resource calendar and resource names. This process performs the copying of sub-project and Master project resource names as described above (e.g. to add a prefix as the file is copied in order to track the source of the data and differentiate equally named resources and calendars). These steps assure consistency of data which will be merged into particular groups of data in the master project file, and handle equally named calendars and resources between various sub-projects and potentially between the sub-project and the master project. These steps complete preparation of processing of a sub-project file to ensure correct incorporation into the master project file. The processed sub-project file data may then be stored and the file closed as depicted at step 133p.

Returning now to FIG. 1, the master project file is again opened and activated at step 134 and at step 135 the sub-projects are disconnected from their physical storage location, adding the sub-project tasks as non-external tasks in the merged master project. As depicted at step 136 the master project file is again saved and closed, to save the task changes that were automatically created during the disconnect action, and to prepare to delete the actual sub-project files. The sub-project files are deleted at step 137, to eliminate any possible connection between the master project and the actual sub-project files and to avoid slowing processing due to potential unnecessary opening and closing of the sub-project files during step 138. (That is, if such sub-files and pointers thereto are allowed to remain at step 138, substantial processing time will be required in opening or attempting to open them, depending on file size.) The master project file is again opened and activated at step 138. The task information now in the master project file is then processed to eliminate any duplicate task links and to revise the pointers which point to information/tasks external to the sub-projects to point to information/tasks which are now internal to the merged master project file as depicted at step 139. To avoid slowing down the processing, as the application makes, for example, each one thousand changes, it is preferred to re-save the file. To speed up this action, only predecessors and successors that contain a “\” in them and do not have a broken link as preferably marked at step 133l need be considered/processed because the “\” represents a link that currently points to another file. The master project file is again saved at step 140, to fully save all of the changes that have been made.

The resulting master project file is then compared against the backup data fields copied at step 127 to determine any task data that may have changed due to the disconnect at step 135 or that violate other issues such as tasks that are linked to other tasks where their links were not updated between the initial files, split tasks with varying split task settings, and the like and the tasks edited and updated to correct the same as depicted at step 141. This editing and correction can be performed automatically by the application. Any tasks that cannot be corrected automatically will be filtered as depicted at step 142 and can be corrected manually. The file merge processing is then completed by saving the master project file and closing the log files as depicted at steps 143 and 144, respectively.

It should be noted that duplicate links can accidentally be created in a file which is to be merged by the invention. Such an accidental creation of duplicate files can occur by performing “Save As” commands while two-cross-linked files are open at the same time. Predecessor and successor fields containing duplicate links so created are difficult to update since all duplicate references in a predecessor field are normally deleted at the time of or before updating data in the predecessor field in order to prevent an error from occurring. If a problem is then found in the predecessor data such as a broken link, the task's Flag1 field is set to “yes” to mark the task as a task that cannot be updated. On the other hand, if flag1 field is still set to “no” after the predecessor update, then the duplicate references in the successors field are updated and the successors field is finally updated.

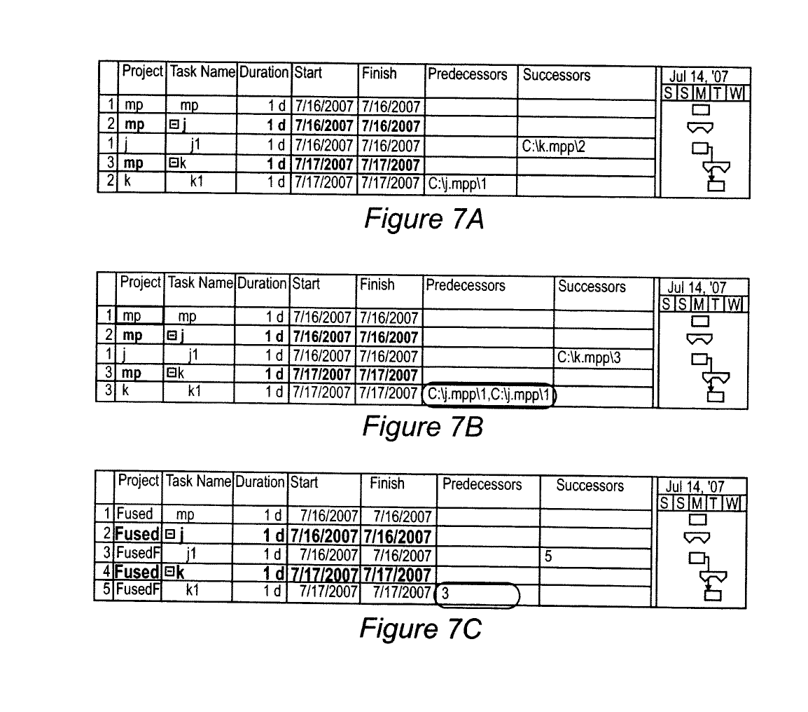

For example, with reference to FIGS. 7A and 7B, assuming that the calculation is set to automatic rather than manual during creation of a file containing two cross-linked files which are open: mp.mpp containing one task called mp, j.mpp containing one task called j1 and k.mpp containing one task called k1 as shown in FIG. 7A. If all three files are then saved and closed and, for example, the j.mpp file is opened and a “File Save As” command is issued to save the file as jtest.mpp, the file will be saved but not closed. Assume then that the k.mpp file is opened and saved and the user then switches to the jtest.mpp file and again performs a “File Save As” command to save the file as j.mpp. This action then overwrites the original j.mpp file. If the j.mpp file and the k.mpp file are now closed, in sequence, and mp.mpp is now opened the duplicate link will now appear as shown in FIG. 7B; the predecessors column now shows two links that match exactly. That is, in task k1 C:\j.mpp\1 is listed two times in the predecessors field. The above processing in accordance with the invention however, removes such duplicate links when updating the link data in step 139 to provide the result as shown in FIG. 7C with the predecessor and successor links reduced to a single, correct line reference each.

Referring now to FIG. 8, a preferred interface for invoking the invention is shown. The screen of the interface identifies the application and provides “file” and “help” options as is customary for most applications. A clear statement of the purpose of the application (e.g. “This application fuses sub projects and a Master Project into one big fused file.”) and a button for access to a User Guide for further information are also preferably provided. It is contemplated that the application in accordance with the invention will typically be invoked after completion of creation or revision of one or more sub-project files which will remain open. The master project file may or may not be open at the time. A box is also provided to indicate fields in all files which will be overwritten or deleted during running of the application (e.g. for reducing file size or reducing likelihood of changing field data). An option box is also provided to allow the option of deleting (or not) particular fields of the document(s) in the course of the merging process and a warning that the application must be run on a copy of the files rather than on the original file (even though, as described above, a further copy is made for reference and validation of the merged document results) in order to be particularly certain that altered information is not reflected back into an original file. Finally, after the above warnings and control options have been presented to a user, the user is provided with option buttons to invoke/launch or exit from the application.

In view of the foregoing, it is seen that the 10 invention provides for merging or “fusing” of files into a single large merged master project file while preventing errors and artifacts such as shifted dates, pointers to external tasks improper handling of equally named resources and calendars, split tasks that are not maintained, duplicate links in original documents and the like being generated as occurs with all commonly known processes and commercially available software for merging project files. In doing so, data irrelevant to the master project file, such as ghost files, is prevented or deleted, either manually or automatically, while the information reflected in other data is scrupulously preserved and necessary settings are matched and made consistent to prevent error generation. Through use of the invention the work to be performed, cost, duration and percentage completion projections and, importantly, schedule dates remain unchanged and distinctly separate calendars are preserved and distinctly separate calendars are provided for each scheduled resource through replication and renaming (but not re-creation) of each calendar, constraints which prevent moving of dates are assigned and retained without modification of dates and linked but un-updated tasks are matched through assignment of constraints.

Again, as can be readily appreciated from FIG. 5 as well as FIGS. 6 and 7 for particular circumstances described above, illustrating the results provided by the invention, the merged master file has been renamed but not recreated; allowing the Master Project file settings to remain unchanged, as is especially important if the default option settings of the user do not match the option settings of the Master Project. All tasks are contained within one merged master file as can be seen from the project field data. Tasks are correctly linked to non-external tasks and not to external tasks and the dates before and after the merge exactly match, even when a task has no successor or predecessor and when cross-project links have not been updated, while critical paths are correctly and unambiguously indicated. Similarly, the work description, cost, date, duration and % complete projections remain the same while constraints may be assigned to tasks as needed to prevent start dates from moving. Note that when task calendars exist, a prefix is added to each task calendar which is included and assigned in the merged master file while data integrity is particularly assured through temporary storage of information in descriptive fields with differentiating prefixes or symbols added before or after such storage to differentiate different file sources before the data is then converted and stored to appropriate final task and resource fields in the merged document. Moreover, the invention assures, by doing so, that each schedule resource has a distinctly separate calendar such that identically named resources in different project files can have different working days and the like by virtue of a prefix added to each resource name's calendar and name to handle differing calendars in a plurality of projects. The sub-project file name is copied into the group field of each resource to allow for re-grouping by file. Further, before merging the Master Project, the sub-project and Master Project resource names may be copied manually or, preferably, automatically into a resource field to allow grouping by identically named resources as alluded to above.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A method of merging document files relating to a project comprising a master project file and sub-project files, said method comprising steps of
validating and backing up all document files to be merged,
backing-up master project file task data to descriptive fields,
resolving inconsistencies between said master project file and said sub-project files using constraints and split task information,
for each sub-project file to be merged:
disconnecting the sub-project file from its physical storage location,
converting pointers pointing to the sub-project file to point to tasks in said master project file to form a converted sub-project file,
deleting duplicate task links to form a converted sub-project file, and
grouping by original project and resource names,
merging each said converted sub-project file with said master project file to form a merged master project file,
differentiating names of equally named resources between sub-project files with varying working calendars, and
updating tasks where task data changed due to said disconnecting step.

2. The method as recited in claim 1, including the further step of
deleting links to files external to said project or which are inaccessible.

3. The method as recited in claim 1, including the further step of
identifying tasks with non-standard constraints.

4. The method as recited in claim 1, including the further step of
copying sub-project file data to a descriptive field in said merged master project file.

5. The method as recited in claim 4, wherein said sub-project file data is a name.

6. The method as recited in claim 5, including the further step of modifying said name.

7. The method as recited in claim 6, wherein said modifying step includes addition of a prefix.

8. The method as recited in claim 4, including the further step of comparing task data in said merged master project file with data in said descriptive field copied in said copying step.

9. The method as recited in claim 1 including the further steps of
determining all files at all sub-levels of all sub-files referenced at any level in said master document or a respective one of said sub-project files, and
ensuring all said files at all sub-levels of all sub-files are available and displayable.

10. The method as recited in claim 9, including the further step of
selecting and counting all files determined in said determining step to determine a task count.

11. The method as recited in claim 10, including the further steps of
filtering all files selected in said selecting step for all tasks included therein,
opening and selecting all files corresponding to tasks resulting from said filtering step,
counting all files selected in said selecting and said opening and selecting steps to determine a further task count, and
comparing said task count and said further task count.

12. The method as recited in claim 11, wherein said steps of selecting filtering, opening and selecting, counting and comparing steps are repeated until said task count and said further task count are found to be equal.

13. The method as recited in claim 10, wherein said filtering step removes grouping of tasks.

14. The method as recited in claim 1, including the further steps of
defining a project group,
grouping tasks in accordance with content of a selected descriptive field, and
comparing content of said selected descriptive field to a project summary task field for a task.

15. The method as recited in claim 1, including the further steps of
determining settings of said sub-project files which must match settings of said master project file,
backing-up task data to descriptive fields,
changing constraints of said task data, and re-naming calendars and resources.

16. The method of claim 15, wherein said determining, backing-up, changing constraints and re-naming steps are performed for each respective one of said sub-project files.

17. The method as recited in claim 15, including the further step of
deleting selected descriptive fields.

18. The method as recited in claim 15, including the further step of
writing split task data to a descriptive field.

19. A computer program product for merging document files relating to a project comprising a master project file and sub-project files, said computer program product comprising a computer readable medium or communication link for supplying signals to control a data processor for performing steps of
validating and backing up all document files to be merged,
backing-up master project file task data to descriptive fields,
resolving inconsistencies between said master project file and said sub-project files using constraints and split task information,
for each sub-project file to be merged:
disconnecting the sub-project file from its physical storage location,
converting pointers pointing to the sub-project file to point to tasks in said master project file to form a converted sub-project file,
deleting duplicate task links to form a converted sub-project file, and
grouping by original project and resource names,
merging each said converted sub-project file with said master project file to form a merged master project file,
differentiating names of equally named resources between sub-project files with varying working calendars, and
updating tasks where task data changed due to said disconnecting step.

20. A computer program product as recited in claim 19 wherein said signals further include signals to control said data processor to perform steps of
determining all files at all sub-levels of all sub-files referenced at any level in said master document or a respective one of said sub-project files, and
ensuring all said files at all sub-levels of all sub-files are available and displayable.
